(19) United States
(12) Patent Application Publication
(10) Pub. No.: US 2009/0041888 A1
(43) Pub. Date: Feb. 12, 2009

(54) USE OF FORMULATED DIETS PROVIDING IMPROVED DIGESTION IN FISH

(75) Inventors: Christopher C. Kohler, Carbondale, IL (US); James E. Wetzel, Carbondale, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SOUTHERN ILLINOIS UNIVERSITY, CARBONDALE, IL (US)

(21) Appl. No.: 11/816,136

(22) PCT Filed: Feb. 13, 2006
(86) PCT No.: PCT/US2006/004838

§ 371 Date: Sep. 2, 2008

Related U.S. Application Data
(60) Provisional application No. 60/652,250, filed on Feb. 11, 2005.

(51) Int. Cl. A23L 1/29; A23L 1/48

(52) U.S. Cl. 426/2; 426/531; 426/89; 426/289

(57) ABSTRACT

The present invention is directed to fish dietary compositions and methods of using to same in order to effect destratification of formulated fish food that is fed to a fish.

This application claims the benefit of priority of prior-filed U.S. provisional application Ser. No. 60/652,250, which was filed on Feb. 11, 2005 and is incorporated herein by reference in its entirety.

### FIELD OF THE INVENTION

This invention is directed to fish food compositions for cultivated fish and methods of cultivating fish that include providing a diet comprising the fish food composition described herein.

### BACKGROUND OF THE INVENTION

With the reduction in fish stocks worldwide, the farm-raising of aquatic organisms for domestic and international consumption has taken on increased importance. Fish are usually raised in fish farms which are situated in open and closed bodies of water including tanks, coastal and freshwater bodies and raceways. The fish farms comprise a plurality of pens, cages or other enclosed areas which constrain the fish and in which the fish are fed and raised. The fish in the enclosures are fed regularly, conveniently by scattering the fish feed on the surface of the water in each of the individual fish enclosures from walkways in a more or less uniform fashion. The feeding rate and amount is judged based on surface feeding activities of fish such as splashing and mouthing as viewed by the farmer from the surface. Feeding is stopped or the rate is reduced if pellets are not consumed before they fade into the water column.

Two of the principal fish species of particular economic interest that are typically farmed are salmon and trout. Other species also raised on fish farms include, but are not limited to, yellowtail, sea bass, tilapia, channel catfish and the like. Salmon and trout, among others, are carnivorous and rely entirely upon the high protein and energy content of their feed for their growth and health.

Compared to land animal feeds, salmon and trout feeds are relatively expensive. From an economic point of view it is important that the fish farmer optimize feeding conditions and avoid overfeeding and underfeeding. In the case of fish reared in sea cages, it is difficult to avoid both over and underfeeding as the conventional dark brown fish feed pellets may not be seen at depth, particularly under conditions of water turbidity, low light conditions such as are present during cloudy days and “shading” in the cages due to the presence of fish. The high organic and nutrient content of fish food causes localized pollution problems in areas of intensive fish farming.

Fish farms using pens or cages in sheltered locations are an environmentally sensitive issue. The accumulation of waste feed and fish feces may lead to nutrient-rich conditions in sediments beneath the fish cages. This can lead to an oxygen imbalance in the area with its concomitant deleterious ecological effects. It is believed that feed waste is normally around 25% or even greater of the feed given. Overfeeding (feeding in excess of the voluntary appetite of fish) wastes feed and pollutes the environment due to feed pellets falling to the sea bed and contributing unwelcome nutrients. This feed wastage also leads to an increase in the amount of feed required per unit weight gain in fish.

Poor feed conversion ratio (FCR) with increasing fish size for fish fed formulated diets has been observed in hybrid striped bass (Morone chrysops×M. saxatilis and M. saxatilis×M. chrysops) and channel catfish Ictalurus punctatus, which together represent the bulk of the U.S. inland warm-water aquaculture industry (Personal communication from the National Marine Fisheries Service, Fisheries Statistics Division, Silver Spring, Md.). Feed costs are usually the most important concern when controlling the cost of fish production; therefore, promoting lower FCR's has been the focus of considerable effort. Research to date has concentrated on nutrient profiles of the formulated diets and the availability of those nutrients to the fish. Generally speaking, animal-derived feedstuffs have proven to be the most efficiently converted to marketable fish products, but plant-based feedstuffs, owing to their much lower cost, are often included in dietary formulations. The FCR associated with a prey diet that has been reconstituted as a pellet is higher in carnivorous fish than if the prey were presented alive. This remains the case even when vitamins and fatty acids that were assumed degraded during processing of the product into the food pellet are added back to the food pellet. Live prey may have nutrients of higher quality, but the formulation and extrusion processing of the components used in formulated feed production may affect the bioavailability of those nutrients as they are processed by the predatory fish's digestive and uptake system.

Feed ration size varies from meal to meal and from day to day and it is a continuous challenge for fish farmers to know when to stop feeding and the optimum amount of feed to use. Feed tables and surface viewing of the pellet by the farmer or operator while feeding are known to be inadequate techniques and result in a lack of control over ration size. However, these methods are common. Currently, the production of one ton of salmon or trout requires between 1.1 and 2.6 tons or higher of dry fish feed. Clearly, the economics of such feeding are of considerable importance to the profitability of fish farms.

Thus, there is a need in the art for a formulated diet for fish.

### SUMMARY OF THE INVENTION

This invention provides a formulated diet for fish. The formulated diet comprises an organic meal, emulsifier, and/or dispersant and/or wetting agent.

In the present invention it has been shown that the presence of an emulsifier component in formulated fish food compositions is a requirement in order to avoid the stratification of food components in the fish gut. As such, the invention provides fish food compositions that comprising at a minimum an organic fish-food meal and an agent that prevents the stratification of the food components of the fish-food meal in the gut of a fish. Typically, the agent that prevents the stratification of the food components of the fish-food meal is an emulsifier. It has been found that inclusion of as little as 0.25% of an emulsifier agent in the formulated fish food provides the beneficial effect of destratification of the foodstuff in the fish gut. Thus, in preferred embodiments, it is contemplated that the agent that prevents the stratification of the food components of the fish-food meal is present in an amount comprising from about 0.25% to about 6.00% of the fish-food composition by weight. Greater amounts of the agent also may be present. Thus, 1%, 2%, 3%, 4%, 5%, 6%, 7%, 8%, 9%, 10% or even more of the composition may be an emulsifier. In specific and preferred embodiments, the emulsifier is one that is traditionally employed in the food industry. Typical agents that prevents stratification of the food components is selected from the group consisting of lecithin (phosphatidyl choline), choline chloride, phosphatidylethanolamine, phosphatidic acid, Polysorbate 60, Polysorbate 65, Polysorbate 80, lysoprin, lysoforte, fatty acid esters of glycerol, sorbitan fatty acid esters, calcium stearate, cholic acid, glycerol monostearate, lactoalbumin, albumin, monoglycerides, diglycerides, sorbitan monostearate, stearyl lactate, hydroxypropyl cellulose, hydroxypropyl methylcellulose, methyl ethyl cellulose, methyl cellulose, polydimethylsiloxane, dimethylpolysiloxane, Polyethylene 40 stearate, polyglycerol esters of interesterified ricinoleic acid, Polyoxyethylene (20) sorbitan monostearate Polyoxyethylene (20) sorbitan tristearate Polyoxyethylene (20) sorbitan monooleate, propylene glycol alginate, propylene glycol mono- and di-esters, propylene glycol esters of fatty acids, sodium lactylate, sodium oleyl lactylate, sodium stearoyl lactylate, sodium phosphates sorbitan monostearate, sorbitan tristearate, sorbitol or sorbitol syrup, sucrose acetate isobutyrate, sucrose esters of fatty acids tannins and tannic acid. Lecithin and Tween (e.g., Tween 20, or Tween 80) are particularly preferred.

The emulsifier may be present in the composition as a coating of the fish food or alternatively, it may be integrated as part of the mass of the fish food. The invention particularly contemplates methods of producing a fish food composition, comprising spraying an emulsifier an organic meal that is typically employed as a fish food to produce the fish food composition of the invention. Extrusion processing is particularly contemplated. The methods of the invention also contemplate producing a fish food composition, comprising blending an emulsifier with an organic meal to produce the fish food compositions described herein.

The foods of the present invention are useful in feeding particularly to fish that are raised in fish-farms. The foods of the invention are used in methods of reducing residuum stratification in the stomach of a fish, comprising providing the fish a diet comprising the fish food compositions described herein, wherein the presence of said emulsifier decreases the stratification of the residuum in the stomach of a fish as compared to a fish food bolus that does not comprise said emulsifier.

The presence of the emulsifiers in the fish food advantageous improve the diet of the cultivated fish. More particularly, the invention contemplates methods of increasing nutrient absorption of a fish, comprising providing the fish a diet comprising the fish food compositions described herein, wherein the presence of said emulsifier allows the food components of said fish-food to remain more unstratified in the stomach as compared to a fish food bolus that does not comprise said emulsifier wherein the greater unstratification of the food comprising said bolus increases nutrient absorption from said fish food by said fish.

The methods of the invention further contemplate decreasing nutrient levels in fecal matter in fish, comprising providing the fish a diet comprising the fish food compositions described herein.

In the methods contemplated herein, the foods are such that the emulsifier in the fish food compositions forms at least 0.25% of the fish's daily diet. Preferably, the emulsifier forms 0.5%, 1%, 2%, 3%, 4%, 5%, 6%, 7% 8%, 9% or more of the fish's daily diet.

By providing the fish a diet comprising the fish food compositions described herein, the invention provides methods of improving the feed conversion ratio in a fish.

Also contemplated are methods of preventing the breakdown of a bolus of formulated fish food in the gut of a comprising coating said formulated fish food in a coating of an emulsifier wherein the presence of said emulsifier reduces the breakdown of the formulated fish food into constituent foodstuff parts of the fish food. More particularly, it has been found that the presence of said emulsifier increases the gastric digestion of said fish food as compared to a similar fish food pellet that does not comprise said emulsifier.

Specific fish foods comprise at least 0.25% lecithin. Greater amounts e.g., 1%, 2%, 3%, 4%, 5%, 6%, 7%, 8% 9%, 10% or more of lecithin are even more desirable. Likewise, the fish foods may also comprise Tween either as an alternative, or in addition to lecithin. 0.25%, 0.5% 1%, 2%, 3%, 4%, 5%, 6%, 7%, 8% 9%, and 10% Tween are particularly preferred.

### BRIEF DESCRIPTION OF THE DRAWINGS

The following drawings form part of the present specification and are included to further illustrate aspects of the present invention. The invention may be better understood by reference to the drawings in combination with the detailed description of the specific embodiments presented herein.

FIG. 1.—Relative gastric evacuation in juvenile largemouth bass Micropterus salmoides at various times after ingestion of one goldfish Carassius auratus meal.

FIG. 2.—Relative gastric evacuation in juvenile largemouth bass Micropterus salmoides at various times after ingestion of a pelleted meal.

FIG. 3.—Estimated dry weight flux over time in juvenile largemouth bass Micropterus salmoides after ingestion of one goldfish Carassius auratus or pelleted meal.

FIG. 4.—Residuum wet and dry weight as a function of post-prandial time in juvenile largemouth bass Micropterus salmoides fed one goldfish Carassius auratus meal.

FIG. 5.—Residuum wet and dry weight as a function of post-prandial time in juvenile largemouth bass Micropterus salmoides fed a pelleted meal.

FIG. 6(A)-(I).—Stomach of spotted bass Micropterus punctulatus A) anterior aspect, B) left lateral aspect and C) ventral aspect; mink Mustela vison D) anterior aspect, E) left lateral aspect and F) ventral aspect; and red-tailed hawk Buteo jamaicensis G) anterior aspect, H) left lateral aspect and I) ventral aspect.

FIG. 7.—Gastric residua (left lateral aspect photograph) of spotted bass Micropterus punctulatus fed a) fat head minnow Pimephales promelas, b) papershell crayfish Orconectes immunis and c) pellets at I) 0.5 h, II) 2.5 h and III) 6.5 h post-prandial.

FIG. 8.—Left lateral aspect illustrations of spotted bass Micropterus punctulatus A) gastric residuum resulting from a pelleted diet with lipid, aqueous, and bolus layers and B) stomach volume with relative positions of esophageal and pyloric sphincters in respect to hypothetical flow of residuum as the stomach evacuates (arrows represent flow).

### DETAILED DESCRIPTION OF THE INVENTION

Residuum stratification is the result of the incomplete digestion of food particles. The term “residuum stratification” refers to the separation of stomach contents during digestion into three distinct layers: bolus (undigested food particles), chyme (partially digested food particles) and lipid. One aspect of the invention is directed to providing methods for reducing residuum stratification in the stomach of a fish is also provided. In one aspect of the invention, the method includes the use of the fish food composition of the invention which comprises at least 0.25% of the fish's daily diet.

Yet another aspect of the invention includes a method of decreasing nutrient levels in fecal matter in fish. In one aspect, the method includes the use of the fish food composition of the invention which comprises at least 0.25% of the fish's daily diet. A method of increasing nutrient absorption by a fish is also provided. In one aspect, the method includes the use of the fish food composition of the invention which comprises at least 0.25% of the fish's daily diet. Such methods may be practiced on any fish, including but not limited to, hybrid striped bass, channel catfish or a teleost fish.

Thus, the present invention provides formulated fish diets with improved digestive properties. In preferred embodiments, the diet is in the form of a pellet. Methods of producing pelleted animal feed are well known in the art and are discussed further below.

Manufactured feeds for farmed fish are normally produced by a process of blending and grinding the ingredients followed by forming the ingredients into pellets. The term “pellets”, however, in this specification as well as the term “feed” is intended to be inclusive of any particle intended to be ingested by fish and variously formulated, including pressed pellets, kibbles, crumbs, moist feeds, and non-feed particles which may include tablets containing drugs, vaccines, or other substances. It is particularly contemplated that the fish food may be provided as dry flakes, pellets, powders, gels, pastes. In embodiments where the food is provided as pellets, pellets may be coated with fish oil or other oil or dietary supplement in order to achieve the desired nutritional profile.

In a method of providing feed for animals in accordance with the present invention, an emulsifier is sprayed on or blended with an organic meal to produce a fish food composition. Preferably, the emulsifier is present in an amount from about 0.25% to about 6.00% on a dry weight basis of the overall fish food content. Exemplary emulsifying agents that are typically employed in foodstuff may be used in the preparation of fish foods for the present invention. Those of skill in the art are aware that exemplary emulsifiers may include, but are not limited to, acetic and fatty acid esters of glycerol; salts (e.g., aluminium, calcium, sodium, magnesium, potassium and ammonium) of fatty acids; ammonium salts of phosphatidic acid; bone phosphate; calcium lactylate; calcium oleyl lactylate; calcium stearoyl lactylate; calcium phosphates; choline salts; citric and fatty acid esters of glycerol; diacetyltartaric and fatty acid esters of glycerol; dioctyl sodium sulphosuccinate; glycerol esters of wood rosins; hydroxypropyl cellulose; hydroxypropyl methylcellulose; lactic and fatty acid esters of glycerol; lecithin; maltitol and maltitol syrup or hydrogenated glucose syrup; methyl ethyl cellulose; methyl cellulose; mixed tartaric, acetic and fatty acid esters of glycerol; mono- and di-glycerides of fatty acids; polydimethylsiloxane or dimethylpolysiloxane; polyethylene (40) stearate; polyglycerol esters of fatty acids; polyglycerol esters of interesterified ricinoleic acid; polysorbate 60 or Polyoxyethylene (20) sorbitan monostearate; Polysorbate 65 or Polyoxyethylene (20) sorbitan tristearate; Polysorbate 80 or Polyoxyethylene (20) sorbitan monooleate; potassium phosphates; potassium polymetaphosphate or sodium metaphosphate; insoluble or sodium polyphosphates; potassium pyrophosphate or Sodium acid pyrophosphate or sodium pyrophosphate; propylene glycol alginate; propylene glycol mono- and di-esters or propylene glycol esters of fatty acids; sodium aluminium phosphate; sodium citrates; sodium lactylate; sodium oleyl lactylate; sodium stearoyl lactylate; sodium phosphates; sorbitan monostearate; sorbitan tristearate; sorbitol or sorbitol syrup; sucrose acetate isobutyrate; sucrose esters of fatty acids; tannic acid and tannins. Preferred such emulsifiers are lecithin (phosphatidyl choline), choline chloride, Polysorbate 60, 65, or 80, lysoprin, lysoforte, fatty acid esters of glycerol, sucrose fatty acid esters and sorbitan fatty acid esters. Although any of these emulsifiers may be used, a particularly preferred emulsifier is lecithin. Other phospholipids, such as phosphatidic acid, phosphatidylethanolamine, phosphatidyl serine and the like also may be used.

It is further contemplated that the emulsifiers may be present in a combination. Thus, for example, a given composition may comprise a mixture of emulsifiers selected from the group consisting of acetic and fatty acid esters of glycerol; salts (e.g., aluminium, calcium, sodium, magnesium, potassium and ammonium) of fatty acids; ammonium salts of phosphatidic acid; bone phosphate; calcium lactylate; calcium oleyl lactylate; calcium stearoyl lactylate; calcium phosphates; choline salts; citric and fatty acid esters of glycerol; diacetyltartaric and fatty acid esters of glycerol; dioctyl sodium sulphosuccinate; glycerol esters of wood rosins; hydroxypropyl cellulose; hydroxypropyl methylcellulose; lactic and fatty acid esters of glycerol; lecithin; maltitol and maltitol syrup or hydrogenated glucose syrup; methyl ethyl cellulose; methyl cellulose; mixed tartaric, acetic and fatty acid esters of glycerol; mono- and di-glycerides of fatty acids; polydimethylsiloxane or dimethylpolysiloxane; polyethylene (40) stearate; polyglycerol esters of fatty acids; polyglycerol esters of interesterified ricinoleic acid; polysorbate 60 or Polyoxyethylene (20) sorbitan monostearate; Polysorbate 65 or Polyoxyethylene (20) sorbitan tristearate; Polysorbate 80 or Polyoxyethylene (20) sorbitan monooleate; potassium phosphates; potassium polymetaphosphate or sodium metaphosphate; insoluble or sodium polyphosphates; potassium pyrophosphate or Sodium acid pyrophosphate or sodium pyrophosphate; propylene glycol alginate; propylene glycol mono- and di-esters or propylene glycol esters of fatty acids; sodium aluminium phosphate; sodium citrates; sodium lactylate; sodium oleyl lactylate; sodium stearoyl lactylate; sodium phosphates; sorbitan monostearate; sorbitan tristearate; sorbitol or sorbitol syrup; sucrose acetate isobutyrate; sucrose esters of fatty acids; tannic acid and tannins. In certain embodiments, a mixture may comprise, e.g., 2, 3, 4, 5, 6, 7, 8, 9, 10 or more of these emulsifiers in varying percentages. For example, mixture of mono- and diglycerides, diacetyl tartaric acid esters of fatty acids, ethanol, sorbitol, polysorbate 20, potassium propionate are commonly used as emulsifiers in the food industry. Such emulsifiers may readily be employed in the fish food compositions in the present invention. Particularly preferred emulsifiers from the food industry that may be useful herein include, e.g., an emulsifier selected from the group consisting of: propylene glycol monostearate (PGMS), sodium stearoyl lactylate (SSL), calcium stearoyl lactylate (CSL), monoglycerides, diglycerides, monodiglycerides, polyglycerol esters, lactic acid esters, polysorbate, sucrose esters, diacetyl tartaric acid esters of mono-diglycerides (DATEM), citric acid esters of monoglycerides (CITREM) and combinations thereof.

The inclusion of lecithin and Tween-80 in pelleted dietary formulations destratifies the gastric residuum of hybrid striped bass. Destratification improves FCR in fish fed diets comprising the fish food compositions described herein. Thus, the invention provides a method of increasing nutrient absorption of a fish, a method of decreasing nutrient levels in fecal matter in fish, and a method of making the fish food composition of the invention.

The emulsifier may be spray coated onto the fish food. Alternatively, the fish food pellets may be dipped into liquid forms of the emulsifier. In other embodiments, the process of preparing the fish food may involve contacting an initial composition comprising the emulsifier in a melted form and the fish food in the appropriate amounts (e.g., the final weight of the emulsifier in the composition is between 0.25% and 6% of the weight of the composition). This mixed composition may then be sprayed to crystallize the mixture such that the emulsifier and the remaining fish food components are integrated. In specific embodiments, it is contemplated that such a method will lead to the encapsulation of the fish food within the emulsifier. In other embodiments, it is contemplated that the emulsifiers are added to the fish food composition as dry components and are substantially dispersed throughout the fish food. Other methods of preparing edible (whether by humans or animals) compositions that comprise emulsifiers are well known to those of skill in the art (see e.g., U.S. Pat. No. 6,096,363).

Aquatic food pellets in the present invention will comprise emulsifier agent in order to facilitate the destratification of the food pellet in its path along the fish gut. Conventional fish food pellets sold for the raising of fish or other aquatic species have been generally of two types and it is contemplated that the emulsifier containing fish food pellets used in the present invention may be produced as such conventional pellets. Typically, fish food pellets have either been of sufficient density to allow them to sink in the water as would be necessary for the feeding of crustaceans or bottom feeding fish, or they have been of a reduced density to allow them to float on the surface of the water. In preferred embodiments, the pellet is preferably a floating pellet.

The floating type of pellet has typically been produced by an extrusion-expansion process rather than a conventional pelleting process because extrusion methods provide a significant decrease in bulk density of certain farinaceous-proteinaceous mixtures caused by gelatinization of the starch from the moisture, temperature and pressure conditions existing in the extruder. Conventional pellet mills, however, will normally not reduce the bulk density of these mixtures. Therefore, all floating aquatic food pellets are typically made using an extruder. The skilled artisan is aware of extrusion techniques for preparing pet foods.

The fish food pellets of the invention are produced by preparing a formulation that comprises the appropriate proteinaceous and farinaceous materials to provide a diet which is nutritionally suitable to various aquatic species such as crustaceans or fishes of various types. Various proteinaceous and farinaceous ingredients may be employed in such a food product for nutritional purposes and the exact formulations desired will be readily apparent and may be varied by one skilled in the art depending on availability of ingredients or the specific aquatic species being fed. Further, it is possible to add or substitute other ingredients or change the ingredient ratios depending on the particular nutritional balance desired.

One embodiment of the invention is to provide an animal feed composition for cultivated fish. The animal feed composition comprises the inclusion of an organic meal, an emulsifier and a dispersant or a wetting agent. Typically, organic meal contains proteins, lipids, carbohydrates, vitamins, minerals such as zinc, iron and manganese, or any combinations thereof which are mixed together and subsequently formed into pellets.

Because protein is the most expensive part of fish feed, it is important to accurately determine the protein requirements for each species and size of cultured fish. Proteins are formed by linkages of individual amino acids. Although over 200 amino acids occur in nature, only about 20 amino acids are common. Of these, 10 are essential (indispensable) amino acids that cannot be synthesized by fish. The 10 essential amino acids that must be supplied by the diet are: methionine, arginine, threonine, tryptophan, histidine, isoleucine, lysine, leucine, valine and phenylalanine. Of these, lysine and methionine are often the first limiting amino acids. Fish feeds prepared with plant (soybean meal) protein typically are low in methionine; therefore, extra methionine must be added to soybean-meal based diets in order to promote optimal growth and health. It is important to know and match the protein requirements and the amino acid requirements of each fish species reared.

Protein levels in aquaculture feeds generally average 18-20% for marine shrimp, 28-32% for catfish, 32-38% for tilapia, 38-42% for hybrid striped bass. Protein requirements usually are lower for herbivorous fish (plant eating) and omnivorous fish (plant-animal eaters) than they are for carnivorous (flesh-eating) fish, and are higher for fish reared in high density (recirculating aquaculture) than low density (pond aquaculture) systems.

Lipids are high-energy nutrients that can be utilized to partially spare (substitute for) protein in aquaculture feeds. Lipids supply about twice the energy as proteins and carbohydrates. Lipids typically comprise about 15% of fish diets, supply essential fatty acids (EFA) and serve as transporters for fat-soluble vitamins. Simple lipids include fatty acids and triacylglycerols. Fish typically require fatty acids of the omega 3 and 6 (n-3 and n-6) families. Fatty acids can be: a) saturated fatty acids (SFA, no double bonds), b) polyunsaturated fatty acids (PUFA, >2 double bonds), or c) highly unsaturated fatty acids (HUFA; >4 double bonds). Marine fish oils are naturally high (>30%) in omega 3 HUFA, and are excellent sources of lipids for the manufacture of fish diets.

Marine fish typically require n-3 HUFA for optimal growth and health, usually in quantities ranging from 0.5-2.0% of dry diet. The two major EFA of this group are eicosapentaenoic acid (EPA: 20:5n-3) and docosahexaenoic acid (DHA:22:6n-3). Freshwater fish do not require the long chain HUFA, but often require an 18 carbon n-3 fatty acid, linolenic acid (18:3-n-3), in quantities ranging from 0.5 to 1.5% of dry diet. This fatty acid cannot be produced by freshwater fish and must be supplied in the diet. Many freshwater fish can take this fatty acid, and through enzyme systems elongate (add carbon atoms) to the hydrocarbon chain, and then further desaturate (add double bonds) to this longer hydrocarbon chain. Through these enzyme systems, freshwater fish can manufacture the longer chain n-3 HUFA, EPA and DHA, which are necessary for other metabolic functions and as cellular membrane components. Marine fish typically do not possess these elongation and desaturation enzyme systems, and require long chain n-3 HUFA in their diets. Other fish species, such as tilapia, require fatty acids of the n-6 family, while still others, such as carp or eels, require a combination of n-3 and n-6 fatty acids.

Carbohydrates (starches and sugars) are the most economical and inexpensive sources of energy for fish diets. Although not essential, carbohydrates are included in aquaculture diets to reduce feed costs and for their binding activity during feed manufacturing. Dietary starches are useful in the extrusion manufacture of floating feeds. Cooking starch during the extrusion process makes it more biologically available to fish.

Examples of organic meals containing the above nutritive ingredients are Menhaden meal, White fish meal, shrimp meal, soybean meal, rapeseed meal, blood meal, herring fish meal, poultry byproducts meal, feather meal, meat and bone meal, cottonseed meal, corn gluten meal, spirulina, dried sour whey, wheat middlings, and dehydrated alfalfa.

Typical ingredients for fish foods include the following list of ingredients, which is intended to represent only a typical nonlimiting listing of various ingredients that can be added or selected for formulating the food product of the present invention: Ground yellow corn (0-45%); Ground Wheat (5-30%); Ground Milo (0-15%); Brewers Yeast (0-2%); Dried Whey (0-4%); Condensed Fish Solubles (5-12%); Defatted Soy Meal or Flour (10-60%); Fish Meal (15-60%); Blood Meal (0-10%); Liver Meal (0-10%) Dehydrated Alfalfa (0-5%); Distillers Grain (0-10%); Dicalcium Phosphate (0-10%); Vitamin Mixture (1-5%); Mineral Mixture (0.5-3%). Exemplary compositions are given in the Tables in the Examples herein below.

A lubricant may be added directly into the combined meal or added to a single ingredient which is then incorporated into the meal. Preferably, the fish food should comprise a nutritionally balanced mixture of various additives which serve as attractants for the aquatic species and make the product of the present invention more appealing in palatability to the particular species involved and among such materials which are suitable include fish solubles, condensed fish solubles, various aliphatic amines and the like. Exemplary compositions for the fish foods, with percentages of individual components are provided in the tables in the Examples herein.

The animal feed compositions comprising the invention further include various buffers, antioxidants and preservatives. Such compositions include diluents of various buffer content (e.g., Tris-HCl, acetate, phosphate), pH and ionic strength; anti-oxidants (e.g., ascorbic acid, sodium metabisulfite), preservatives (e.g., Thimersol, benzyl alcohol) and bulking substances (e.g., lactose, mannitol).

The animal feed composition comprising the invention may further include vitamins and minerals. Vitamins are organic compounds necessary in the diet for normal fish growth and health. They often are not synthesized by fish, and must be supplied in the diet. The two groups of vitamins are water-soluble and fat-soluble. Water-soluble vitamins include: the B vitamins, choline, inositol, folic acid, pantothenic acid, biotin and ascorbic acid (vitamin C). The fat-soluble vitamins include A vitamins, D vitamins, E vitamins, the tocopherols (antioxidants); and K vitamins such as menadione. Minerals required by fish include calcium, phosphorus, sodium, potassium, magnesium, iron, copper, zinc, cobalt, selenium, iodine, and fluorine. Exemplary minerals compositions are given in Appendix Table 2.

Methods of making the animal feed pellets are well known to those of skill in the art and have been described e.g., in U.S. Pat. Nos. 4,963,371; 4,800,088; 4,171,385; 4,234,608 and 4,393,087. Each of these exemplary is incorporated herein by reference for providing a teaching of general techniques for the preparation of feed pellets. U.S. Pat. No. 4,393,087 is incorporated herein by reference as further providing a teaching of producing aquatic food pellets and the components of such food pellets.

Animal feeds are generally produced with low cost byproduct ingredients. These ingredients are often dusty, unpalatable, of low density, and have inadequate nutrient profile. To correct these shortcomings, ingredients are combined into a mixture with the necessary vitamins, minerals, and amino acids to meet the nutrient requirements of the animals. This is normally accomplished by extrusion and/or compaction techniques to form pellets, blocks, or briquettes. Extrusion and compaction eliminate ingredient segregation, increase bulk density, reduce dust, mask unpalatable ingredients, and reduce wastage.

The animal feed may be prepared by any method known in the art or otherwise found to be suitable. Generally speaking, the animal feed is prepared by combining the ingredients of the animal feed to form a mixture, and forming discrete plural particles of the animal feed from the mixture. Most preferably, the particles are formed by pelletizing the mixture. Those skilled in the art of pelletizing will appreciate that various conditions may be employed during the pelletizing process. Generally speaking, moisture levels in the pellet mill may range from about 5% to about 12%, with a product temperature ranging from about 120° F. to about 250° F. In the preparation of one horse feed, for instance, the pelletizer was operated under the following conditions:

| Feed Rate | 1 lb./min |
|---|---|
| Feed Moisture | 9.0% |
| Conditioner Temperature | 145° F. |
| Mill Die | 3/16 in. × 11/2 in |
| Mill RPMs | 450 |
| Mill amps | 2.8 |
| Product Temperature | 145° F. |
| Product Moisture | 10.5% |

The pelleting process consists of proportioning ingredients to meet the desired nutrient specifications, mixing, conditioning the mixture with steam, and extruding the conditioned meal through a die. Resistance in the die provides compaction necessary to form the pellet. Different ingredients will affect the resistance to extrusion and thereby affect pellet durability and production efficiency. Low resistance may require a binding agent while excessive resistance may require a lubricant. The above pelletizing techniques can readily be adapted for formation of fish food pellets.

Commercial pellet binders may be added to animal feeds to help maintain the physical integrity of the feed pellets. Chemically reactive binders have been used, as set forth in U.S. Pat. No. 4,996,065 (Van de Walle). These binders rely on a mixture of metal oxides and phosphates which react during pelleting to produce a metal phosphate cement-type compound which sets and strengthens the pellet. Alternatively, metal oxides have been combined with liquid molasses to form “gels” which lock ingredients together into a solid block, as described in Canadian Patent 1,206,368 (Graham).

A method of producing the fish food composition of the invention is also provided. In one aspect a method is provided comprising spraying an emulsifier on an organic meal.

The invention is illustrated by the following examples, which are not intended to be limiting in any way.

### EXAMPLES

### Example 1

### Formulated Pelleted Diet can Cause Poor Digestion in Fish

Black basses Micropterus spp. are among the most thoroughly studied fish taxa in terms of feed conversion of natural and formulated diets and are typical of many fish used in aquaculture in that they are predators on other organisms, usually fish. A pattern involving FCR and fish size was observed in feeding trials involving largemouth bass M. salmoides and its relative the smallmouth bass M. dolomieu. When feeding on natural prey they typically convert one pound of prey dry weight to one pound of bass live weight gain. In contrast, bass fed formulated diets exhibit a similar FCR when small (<10% market weight), but as market weight is approached, FCR increases and approaches 2:1 (Table 1.). FCRs in largemouth bass for direct human consumption easily exceed 2:1 with larger fish.

In order for black basses to exhibit higher growth when fed pelleted formulated diets, they must consume more per unit of growth than they would if consuming natural prey. Increased rates of food processing for pelleted formulated diets by the stomach are thus required. The simplest measure of food processing is gastric evacuation otherwise known as the rate at which the stomach is emptied after a meal is ingested.

We conducted a study where largemouth bass were fed either a meal of live goldfish or a pelleted formulated diet. Kinetics of gastric processing/evacuation were compared between the two meal types.

Materials and Methods

Pond cultured age-1 juvenile largemouth bass (n=150) were feed trained using freeze-dried krill transitioned to the pelleted diet formulation (Table 2) according to Kubitza and Lovshin (1997). Paprika was included to facilitate defining bounds of residuum in reference to the esophagus and pyloric sphincter. Feed trained bass (mean=12 g) were graded, individually weighed and stocked into 102 individual confinement units with six units per 170-L aquarium (n=17) in a water reuse system (see Chapter 7). Acclimation to individual confinement (duration 5 d) involved feeding bass once daily at 1000 h with meals of the dietary treatment (goldfish or pellets) approximating the size to be used in the trial (1 goldfish˜1.20 g; pelleted diet formulation˜0.35 g). Meal size was chosen to ensure bass immediately fed to completion. Feed was withheld to experimental animals on day 6 and bass were measured for standard length (SL; mean=90.8±6.0 mm and live weight (mean=14.998±3.129 g). Goldfish were maintained in the same water reuse system as the bass and fed twice daily to apparent satiation with a commercially available fish feed (Bio-Blend® Tropical Fish Food, Marineland Labs, Moonpark, Calif.; 42% crude protein) until 48 h before the trial when feed was withheld. Four hours before the trial, goldfish and pellets were weighed to the nearest 0.001 g and stored in either aquarium fish bags (goldfish) or stoppered test tubes (pellets) in a refrigerator at 10 C. Dry weight to as-fed weight ratio of pelleted diet formulation was 0.913 and a sub-sample of 6 goldfish was used to estimate the live weight to dry weight relationship [Dry Weight (0.001 g)=0.1549 (Live Weight 0.001 g)+0.022 g; r²=0.957].

The trial started at 1000 h with subjects fed at 2 min intervals with feeding time recorded. When possible, 4 bass were sampled per treatment per 2.5 h post-prandial interval. Sampled bass were promptly frozen in liquid nitrogen and processed for gastric residua. Goldfish meal average live weight was 1076±231 mg and dry weight was 190±41 mg, resulting in a relative meal sizes on a live weight and dry weight basis of 7.3±1.8 and 1.3±0.3%, respectively. Pellet meal average wet weight was 346±21 mg and dry weight was 316±20 mg, resulting in a relative meal sizes on a wet weight and dry weight basis of 2.4±0.5 and 2.2±0.5%, respectively. Residuum wet and dry weights (AOAC 1990) were compared to bass live weight (see Appendix 8.1 for summary of data). Relative gastric evacuation was calculated as w−s/w, where w=meal size (mg dry weight) and s=gastric residuum (mg dry weight) and related to post-prandial time.

Data were analyzed using a model that combines two types of gastric evacuation kinetics, linear and curvilinear (assumed to be exponential decay). Linear decay was assumed to occur first in the digestive process, up until time Θ, and was described by the equation y=1+b*x. After time Θ the process was modeled as an exponential decay using the equation y=(1+b*Θ)*exp(d*(x−Θ)). The constant b=slope during the linear segment and d=exponential decay constant. The model was fitted to the data using non-linear regression following the SAS procedure NLIN (SAS Institute 2001). The form of model was chosen so that two curves joined at time Θ. An estimated value of time Θ near zero implies purely exponential decay, Θ>0 implies a mixture of the two processes, and Θ estimated to coincide with completion of gastric evacuation implies a purely linear process. Where PROC NLIN did not find models convergent the linear component was omitted. Dry weight flux relative to mean bass weight was estimated using the first derivative of the gastric evacuation models as a function of time multiplied by mean meal dry weight size for each treatment.

Conclusion

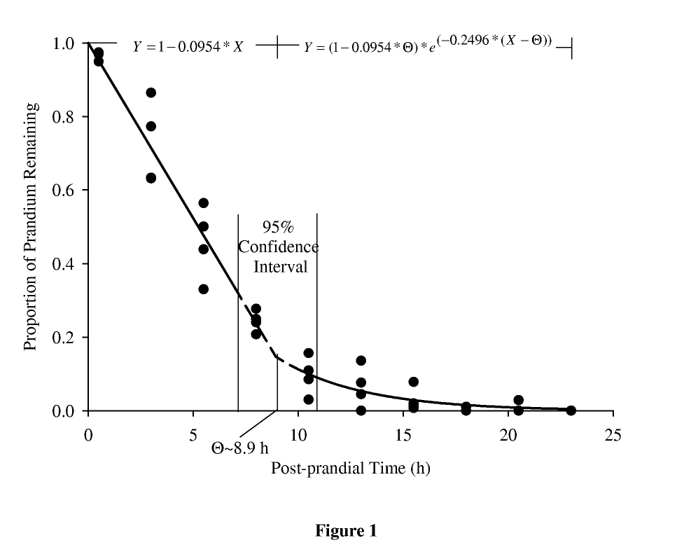

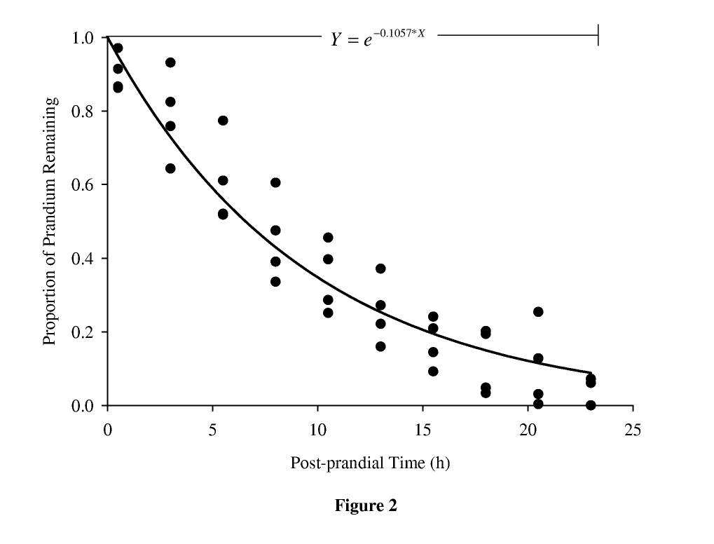

Kinetics of gastric evacuation in largemouth bass fed a live goldfish meal was linear until ˜85% of the meal dry matter is evacuated (FIG. 1). This result is very similar to that observed for spotted bass Micropterus punctulatus fed a typical larger meal of live prey (Wetzel 2004). Largemouth bass fed a formulated diet (FIG. 2) exhibited a non-linear pattern of gastric evacuation on a dry matter basis.

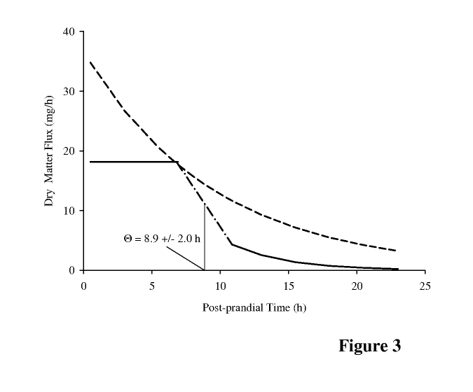

Inferred flux of dry matter from the stomach in the intestinal tract based on the gastric evacuation models indicates goldfish and the pelleted formulated diets were processed differently (FIG. 3). Goldfish were evacuated in a constant/regulated matter directly associated with dry matter of the material evacuated until ˜85% of the meal was evacuated. Contrarily, the pelleted formulated meal evacuation rate started much higher, was more variable and tended to decline as the stomach emptied suggesting that initially the regulatory mechanism required more dry matter to be evacuated before engaging. The disparity in passage rate is the reason observed differences in feed intake and resultant FCR.

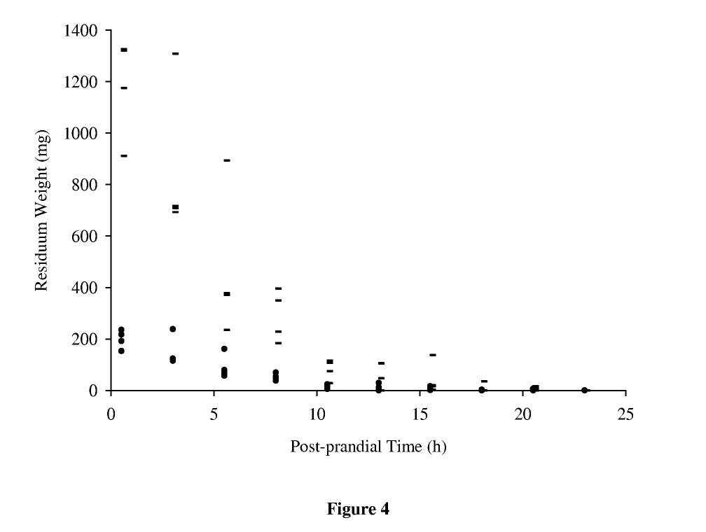

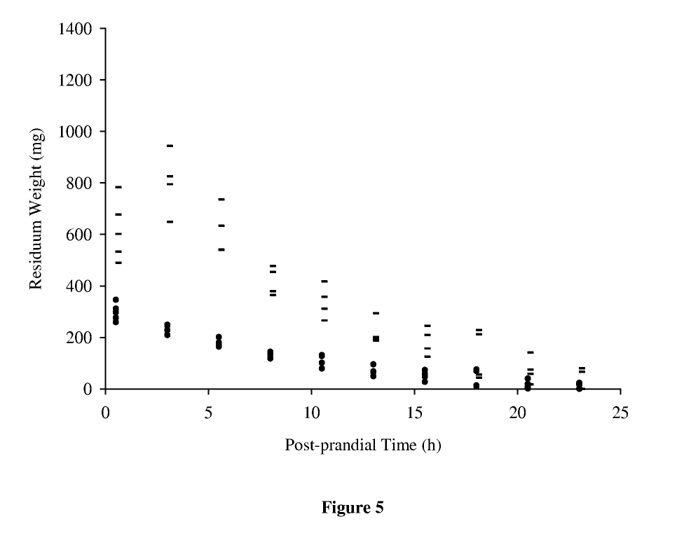

Another difference between kinetics of gastric processing of natural prey and a formulated diet in largemouth bass was observed when comparing residuum (=wet and dry gut contents) weights to post-prandial time (FIGS. 4 and 5). Goldfish residuum decreased in measures of wet and dry matter throughout the gastric processing phase while the formulated diet residuum increased considerably in terms of wet weight during the first 2.5 h post-prandial and then decreased thereafter. Even though the formulated diet meal initially possessed a considerably higher dry matter weight (as a function of what the bass would consistently consume in a single feeding), the increase in wet weight never matched that of a smaller goldfish meal, indicating the residuum dry matter contents processed by the stomach differed considerably as a function of meal type. It is likely that with the pelleted formulated diet, the first material evacuated had much lower moisture content than material evacuated later. Digestive fluids require a wet surface upon which to act.

A final difference between the meal types was made visible by our sampling technique and relates to the general appearance of the residuum. The goldfish meal resulted in a residuum with a bolus that was centrally located and dominated the bulk of the stomach volume with the fluidized chyme layer representing only a small proportion of the stomach volume and was largely restricted to where the bolus was in contact with the stomach lining. The pelleted formulated meal resulted in a residuum that tended to have three distinct layers/strata.

### Example 2

### Stratification of the Gastric Residuum Associated with a Pelleted Formulated Diet is not Typical in Carnivorous Fish

Stratification of the gastric residuum has been observed in chum salmon Oncorhynchus keta, other pacific salmon Oncorhynchus spp. and fresh-water pond-smelt (Ishada, 1949; Allen and Aron, 1958; Ueno, 1968). Those instances of stratification were considered to be a function of differing plankton morphology/sizes or the order in which they were consumed. Stratification of the gastric residuum has not been reported for fish fed pelleted meals. The sampling methodology (rapid freezing of samples in liquid nitrogen) reported in the previous example was crucial for its discovery. Stratification of the gastric residuum is known for homeotherms that triturate/chew their food but the relevance of its occurrence in fish has not been considered previously.

The present example reports the appearance of the gastric residua in spotted bass M. punctulatus formed from meals of natural prey items (fathead minnows Pimephales promelas and papershell crayfish Orconectes immunis) as compared to a formulated diet. The relevance of residuum form is explained as it relates to stomach morphology for the macrophagus predators such as many fish used in aquaculture as well as two terrestrial homeotherms (mink Mustela vison and red-tailed hawk Buteo jamaicensis).

Materials and Methods

Residuum appearance: Nine pellet trained sub-adult spotted bass (mean weight=150 grams) were maintained in isolation in 37.8 L glass aquariums for seven days. During days 1-5, the bass were hand-fed to satiation once daily with either a semi-purified pellet diet (See Table 2), live paper shell crayfish (Orconectes immunis), or live fathead minnows (Pimephales promelas). Three bass were given each dietary treatment. Crayfish and minnows were maintained on the same pelleted diet as the bass and fed to apparent satiation two times daily. On Day 6, food was withheld to allow complete evacuation of gastric contents. On Day 7, the bass were fed that same food as during Days 1-5, at a rate of approximately 2% of their body weight (dry weight of feed/wet weight of bass). Post-prandially (4.5 hours) the bass were dispatched with blunt trauma to the head before immersion in liquid nitrogen until frozen solid (approx. 2 mins.). The bass were stored frozen until the residuum was removed by dissection. The position of the pyloric sphincter was noted relative to the observed strata. Representative residua were photographed. Residuum strata were separated using a razor blade for determination of proximate composition.

Stomach morphology: Northern spotted bass Micropterus punctulatus punctulatus were F1 (gross morphology; n=2) or F2 (residuum; n=9) from Hutchins Creek, Union County, Ill. Animals were pond reared at the Southern Illinois University, Fisheries and Illinois Aquaculture Center, Illinois Aquaculture Research and Demonstration Center, Jackson County, Ill. One farm raised mink was obtained from Michigan University and one red-tailed hawk Buteo jamacianses was road-kill obtained from the Southern Illinois University, Cooperative Wildlife Labotatory. Comparison of gross gastric morphology were made using one of each of the following: mink (880 grams); red-tailed hawk (1206 grams), with a nearly saturated gastrointestinal tract; and spotted bass (˜1000 grams), fed to satiation on fathead minnows for 30 minutes. All freshly killed animals were stored frozen until dissected. Drawings of gastric volume and photographs of intestinal tracts were rendered. Contents of red-tail hawk crop and gastric volumes were identified and weighed (wet weight).

Conclusion

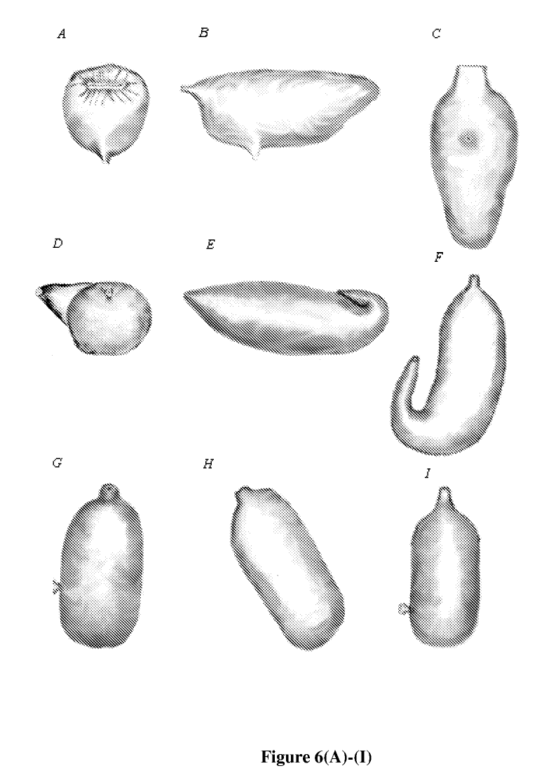

Stomach morphology: Stomach design differs considerably between these species (FIG. 6). The spotted bass Micropterus punctulatus, which is typical of many predatory fish used in aquaculture, swallows prey whole with gastric chemical digesting preceding trituration. The mink and red-tailed hawk triturate as they ingest a meal, chew and dismember, respectively. The spotted bass like most cultured fish species has a ventrally located pyloric sphincter. The mink and red-tailed hawk have pyloric sphincters that are elevated above the bottom of the stomach. The pyloric sphincter is positioned in both homeotherms such that it is elevated relative to the lowest point in the stomach when the animal stands in its normal posture. The red-tailed hawk has a pyloric sphincter to the right side approximately at the top of the stomach's bottom third. The mink has a pyloric sphincter on the elongated posterior end of the stomach that is elevated and also to the right.

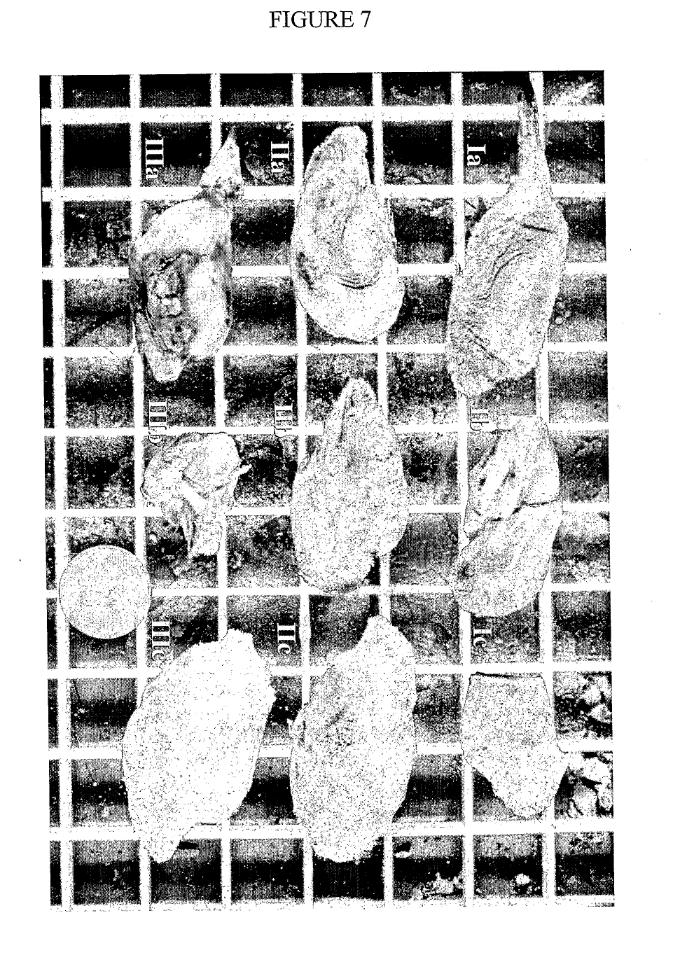

Residuum appearance: Visual inspection of the spotted bass from a lateral aspect of post-prandial gastric residua revealed obvious differences as a function of dietary treatment and time (FIG. 7). Fat-head minnow residua had largely intact prey items (bolus particles) with only minor digestion of the integument 0.5 h post-prandial (Ia), with increasing degradation and increasing chyme forming around bolus particles at 2.5 h (IIa) and 6.5 h (IIIa) post-prandial. Digestion of the bolus particles was most rapid in areas in direct contact with the gastric lining. Crayfish derived residua displayed very little digestion of the exoskeleton or chyme around the bolus (Ib, IIb, IIIb). As time progressed, the crayfish exoskeleton softened and disarticulated but remained in context with adjacent segments telescoping into each other resulting in shrinking of the residuum volume.

The pelleted diet resulted in a change in gastric residuum appearance that was completely different from other diets (Ic, IIc, IIIc). The residuum formed from a pelleted diet at 0.35 h post-prandial (Ic) was homogenous with pellets breaking down into constituent feedstuffs and dominated by a single bolus. The 2.5 h post-prandial pellet residuum increased in volume and has three distinct layers. The particulate bottom layer (bolus) is overlain by a white layer that is aqueous. The top layer is largely lipid that contrasts from the aqueous layer owing to the presence of lipid soluble pigments (carotenoids from paprika). The residuum 6.5 h post-prandial is very similar in volume to the 2.5 h post-prandial volume with the proportion represented by the aqueous layer increasing as the bolus decreases. Residuum, until at least 6.5 h post-prandial, is evacuated largely as chyme with diets of fat-head minnow and crayfish as made evident by lack of particulates in the posterior intestines and pyloric cecca. Evacuation associated with a pelleted diet is dominated by particulates from the bolus, even at 0.5 h post-prandial, with particulates in the small intestine and the pyloric cecca.

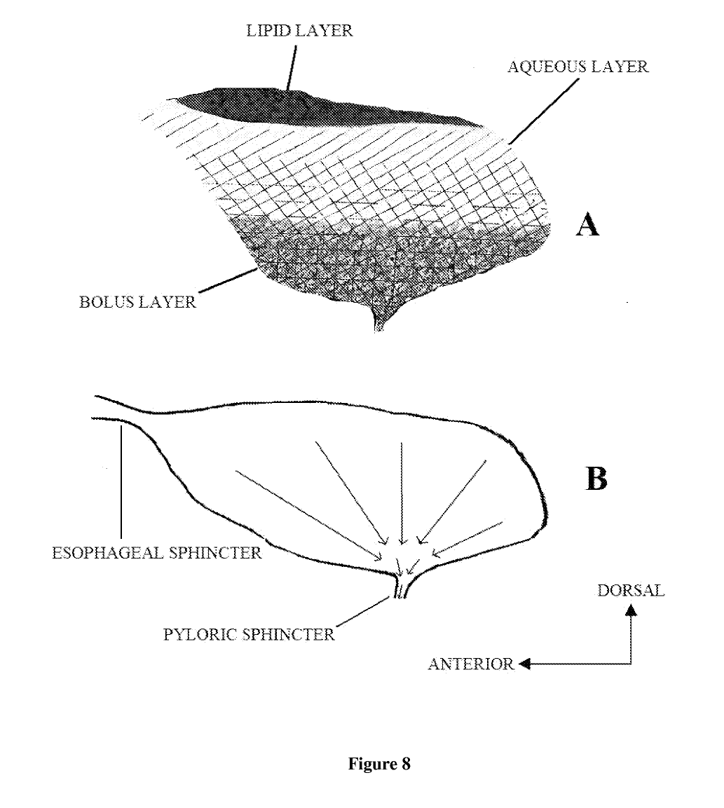

Stomach morphology/residuum appearance interaction: Stratification of the gastric residuum appears inconsistent with the stomach design of spotted bass and likely for most carnivorous fish species with similar stomach designs. In spotted bass fed natural prey, bolus size prevents passage prior to conversion to chyme. Contrarily, spotted bass having to contend with stratified gastric residuum have bolus particulates that are small enough and positioned directly over the pyloric sphincter to be evacuated first, before conversion to chyme (see illustration of largemouth bass gastric residuum and stomach cross-section FIG. 8). The elevated position of the pyloric sphincter in mink and red-tailed hawk provides a mechanism for retaining triturated particulates of a similarly stratified gastric residuum.

In spotted bass fed the pelleted formulated diet the first material to be evacuated is relatively dry. Dry bolus material entering the upper intestinal tract may stimulate the rapid influx of water, which effectively separates the bolus and lipid layers. The influx of water clearly occurs post-prandially and can exceed half of the residuum weight on a wet-weight basis. The influx of water is rapid and can sometimes actually be seen in progress as the fish's body becomes greatly distended after a large meal. The distension associated with some formulated meals can exceed even the largest distension associated with a meal of natural prey, and rupture of the visceral cavities of hybrid striped bass has been observed.

The first problem with respect to the stratification of the residuum from formulated feed indicates poor mixing of gastric digestive fluids and reduced subsequent exposure of undigested particulates. Gastric digestion of particulates facilitates liberation of nutrients and their uptake by the intestines and is the probable reason why a feedback regulatory mechanism allows such high rates of evacuation as demonstrated in example 1 with largemouth bass fed the pelleted formulated diet.

The second problem involves how the predatory fish's pyloric sphincter position interacts with stratification of the gastric residuum. The pyloric sphincter position on the ventral (bottom) of the stomach means the bolus, which settles to the bottom of the gastric volume as a function of stratification, is the first in line to be evacuated.

Finally, stratification of ingested formulated feed may result in nutrients being evacuated into a carnivorous fish's intestine sequentially rather than synchronously. Delayed evacuation of lipids and lipid soluble components (vitamins A, K, and E) could potentially limit their assimilatory efficiencies and/or those of nutrients where simultaneous uptake and/or assimilation is optimal.

The phenomenon of stratification associated with pelleted formulated diets is due to the following reasons. Firstly, pellets are made of dried and milled foodstuffs. Post-prandially pellets rapidly breakdown into the constituent feedstuff millings. The relatively dense feedstuffs making up the bolus do not suspend on their own; the churning motion of carnivorous fish stomachs appears to be limited.

### Example 3

### Properly Formulated Pelleted Diet can Reduce Stratification in Stomachs of Fish

De-stratification of the gastric residuum in carnivorous fish can be achieved through the use of food additives such as emulsifiers, wetting agents and dispersants.

Herein, the use of the exemplary emulsifier lecithin is described for use in the preparation of pelleted formulated diets to de-stratify the resultant gastric residuum in a carnivorous fish used in aquaculture.

Materials and Methods

Juvenile sunshine bass Morone chrysops×M. saxatilis (n=15) were stocked individually into 110 L tanks and acclimated for a period of five days. During the acclimation bass were fed the control diet (Table 4) at a rate of 4% of their body weight per day (BWD) on a dry weight basis. Feed was divided evenly over two feedings at 1000 and 1600 h. Day six feed was withheld. Day seven at the time of the 1000 feeding 3 randomly assigned bass were fed 2% BWD of one of the five diets containing 0 (=control), 0.25, 0.50, 1.00, or 2.00% lecithin (Table 4.). At 4.5 h post-prandial bass were sampled as in example 2 and residua were examined for evidence of stratification.

Conclusion:

Lecithin inclusion rates of 0.25, 0.50, 1.00, and 2.00% of the weight of the fish food pellet reduce stratification of the gastric residuum. Lecithin inclusion rates of 0.50, 1.00, and 2.00% reduce the amount of post-prandial water intake into the gastric residuum.

Food additives which de-stratify the gastric residuum 1) improve mixing of residuum and digestive fluids, 2) moderate post-prandial water uptake that increases the likelihood of chyme loss associated with regurgitation, and 3) increase the synchronicity of nutrients from the gastric volume into the intestine such that the nutrient profile of the chyme throughout the gastric processing cycle reflects the nutrient profile of the diet formulation.

### Example 3

### Effects of a Non-Nutrient Emulsifier in Practical Diets Fed to Juvenile Hybrid Striped Bass

The present example provides details of experiments conducted to evaluate and quantify the effects of a non-nutritive emulsifier upon the growth and feed efficiency of phase-I hybrid striped bass (Morone chrysops×M. saxatilis). Tween-80® (provided as a liquid supplement) was incorporated into practical diets formulated to meet, or exceed, the known nutrient requirements of hybrid striped bass. Diets were formulated at Southern Illinois University using MIXIT 3 WIN (Agricultural Software Consultants, Inc., San Diego) and manufactured as cold pressed pellets.

Fish were stocked at a density of 15 fish per tank. Four practical diets were formulated to meet or exceed the known dietary requirements of juvenile hybrid striped bass. Each diet was supplemented with one of four concentrations of emulsifier providing dietary treatments of 0, 0.5, 1.0, and 2.0% Tween-80®, respectively. Fish were fed daily to satiation and feed consumption was monitored weekly. After 4 weeks, all fish in each tank were weighed to determine growth. Feed consumption was used to calculate feed conversion ratio (g feed:g weight gain). The findings for the trial are listed in the following Table:

Weight gain and feed conversion ratio (g feed:g gain) of hybrid
striped bass (Morone chrysops X M. saxatilis, initial weight 15 g)
fed practical diets supplemented with a non-nutritive emulsifier
(Tween-80 ®^{a}) for 28 days.

| % Tween-80 ® | Weight Gain (%) | FCR |
|---|---|---|
| 0 | 100 | 1.28 |
| 0.5 | 118 | 1.21 |
| 1.0 | 140 | 1.16 |
| 2.0 | 125 | 1.23 |

^{a}Tween-80 ® was provided by Archer-Daniels Midland, Inc.

This study showed that use of a non-nutritive emulsifier in practical diets fed to juvenile hybrid striped bass improved weight gain and feed conversion of fish fed the test ingredient when compared to fish fed a control diet void of Tween-80®.

From the foregoing it will be appreciated that, although specific embodiments of the invention have been described herein for purposes of illustration, various modifications may be made without deviating from the spirit and scope of the invention.

### LITERATURE CITED

Anderson, R. J., E. W. Keinholz, and S. A. Flickinger. 1981. Protein requirements of smallmouth bass and largemouth bass. Journal of Nutrition 111:1085-1097.

Brandt, T. M., and S. A. Flickinger. 1987. Feeding largemouth bass during cool and cold weather. The Progressive Fish-Culturist 49:286-290.

Brecka, B. J., D. H. Wahl, and M. L. Hooe. 1996. Growth, survival, and body composition of largemouth bass fed various commercial diets and protein concentrations. The Progressive Fish-Culturist 58:104-110.

Kubitza, F., and L. L. Lovshin. 1997. Pond production of pellet-fed advanced juvenile and food-size largemouth bass. Aquaculture 149:253-262.

Lagler, K. F. and T. E. Kruse. 1953. Food conversion in black basses of the genus Micropterus. Journal of Wildlife Management 17:219-221.

Lewis, W. M., R. Heidinger, and M. Konikoff. 1969. Artificial feeding of yearling and adult largemouth bass. The Progressive Fish Culturist 31:44-46.

Portz, L., J. E. P. Cyrino, and R. C. Martino. 2001. Growth and body composition of juvenile largemouth bass Micropterus salmoides in response to dietary protein and energy levels. Aquaculture Nutrition 7:247-254.

Prather, E. E. 1951. Efficiency of food conversion by young largemouth bass Micropterus salmoides (Lacepde). American Fisheries Society 80:154-157.

Smagula, C. M., and I. R. Adelman. 1982. Day-to-day variation in food consumption by largemouth bass. Transactions of the American Fisheries Society 111:543-548.

Tidwell, J. H., C. D. Webster, and S. D. Coyle. 1996. Effects of dietary protein level on second year growth and water quality for largemouth bass (Micropterus salmoides) raised in ponds. Aquaculture 145:213-223.

Whitledge, G. W., and R. S. Hayward. 1997. Laboratory evaluation of a bioenergetics model for largemouth bass at two temperatures and feeding levels. Transactions of the American Fisheries Society 126:1030-1035.

Williams, W. E. 1959. Food conversion and growth rates for largemouth bass and smallmouth bass in laboratory aquaria. Transactions of the American Fisheries Society 88:125-127.

Williamson, J. H., and G. J. Carmichael. 1990. An aquacultural evaluation of Florida, Northern, and hybrid largemouth bass, Micropterus salmoides. Aquaculture 85: 247-257.

TABLE 1
Summary of studies involving largemouth bass Micropterus salmoides
(LMB) and smallmouth bass M. dolomieu (SMB) wet and dry weight feed conversion
ratio (FCR-W and FCR-D, respectively) when fed live prey and pelleted dietary
formulations.

| Species | Author(s) | Natural Forage | Formulated Diet |
|---|---|---|---|
| LMB | Williamson and Carmichael | | FCR 1.24-1.73 |
| | (1990) | | semi-moist grower/daily |
| | | | juvenile 1.25-(74-117) g |
| LMB | Williams (1959) | FCR-W 3.8 | |
| | | FCR-D 0.95 | |
| SMB | Williams (1959) | FCR-W 4.5 | |
| | | FCR-D 1.13 | |
| LMB | Whitledge and Hayward | FCR-W 5.1 | |
| | (1997) | FCR-D 1.28 | |
| LMB | Tidwell et al. (1996) | | FCR 2.0 |
| LMB | Smagula and Adelman | FCR-W 4.25 | |
| | (1982) | FCR-D 1.06 | |
| LMB | Prather (1951) | FCR-W 4 | |
| | | FCR-D 1 | |
| LMB | Portz et al. (2001) | | FCR 0.96-1.37 |
| | | | Small juveniles^{b} |
| LMB | Lewis et al. (1969) | FCR-W 22-17 | FCR 4-8 |
| | | FCR-D 5.5-4.25 | |
| LMB | Lagler and Kruse (1953) | FCR-W 4.0 | |
| | | FCR-D 1 | |
| SMB | Lagler and Kruse (1953) | FCR-W 3.5 | |
| | | FCR-D < 0.88 | |
| LMB (0+)^{a} | Kubitza and Lovshin (1997) | | FCR 1.1 |
| LMB (1+) | Kubitza and Lovshin (1997) | | FCR ≦ 1.4 |
| LMB (0+) | Brecka et al. (1996) | | NO FCR (>2) |
| | | | Fed to excess |
| LMB (0+) | Brandt and Flickinger (1987) | | FCR 1.9 |
| | | | Biodiet as fed |
| LMB (0+) | Anderson et al. (1981) | | FCR 1.05-1.89 |
| SMB (1+) | Anderson et al. (1981) | | FCR 1.05-1.89 |
| LMB (0+) | Anderson et al. (1981) | | FCR 1.33-2.38 |
| SMB (1+) | Anderson et al. (1981) | | FCR 1.59-4.55 |

^{a}age class
^{b}data likely erroneous based on extremely low feed intake rates and inconsistencies in calculations in growth rate variables

TABLE 2
Diet formulation for pellets fed to juvenile largemouth bass
Micropterus salmoides for comparison with goldfish
Carassius auratus in a gastric evacuation trial.
Ingredients as a proportion of total formulation dry weight.

| Ingredient | Ratio of Total Diet |
|---|---|
| Mehaden Fish Meal | 0.580 |
| Dextrin | 0.010 |
| Menhaden Fish Oil | 0.233 |
| Vitamin Premix^{a} | 0.010 |
| Mineral Premix^{b} | 0.040 |
| Choline-Cl | 0.005 |
| Ascorbic Acid | 0.005 |
| Carboxy-methyl-cellulose | 0.020 |
| Paprika | 0.020 |
| Cellulose | 0.077 |
| Total | 1.000 |

^{a}see appendix 1
^{b}see appendix 2

TABLE 3
Diet formulation for pellets fed to sub-adult spotted bass
Micropterus puntulatus for comparison with fathead minnow
Pimephales promelas and papershell crayfish Orconectes immunis
meals as gastric residua at 0.5, 2.5 and 6.5 h post-prandial.
Ingredients as a proportion of total formulation dry weight.

| Ingredient | Ratio of Total Diet |
|---|---|
| Menhaden Fish Meal | 0.5800 |
| Dextrin | 0.0300 |
| Menhaden Fish Oil | 0.2330 |
| Vitamin Premix¹ | 0.0100 |
| Mineral Premix² | 0.0400 |
| Choline-Cl | 0.0050 |
| Ascorbic Acid | 0.0050 |
| Carboxy-methyl-cellulose | 0.0200 |
| Paprika | 0.0200 |
| Cellulose | 0.0570 |

¹Appendix 1.
²Appendix 2.

TABLE 4
Diet formulation for pellets with varied levels of lecithin inclusion fed
to juvenile sunshine bass Morone chrysops x M. saxatilis
in trail investigating the affects on stratification of the gastric
residuum 4.5 h post-prandial. Ingredients as a proportion
of total formulation dry weight.

| | Diet | | | | |
|---|---|---|---|---|---|
| | Lecithin 0% | Lecithin | Lecithin | Lecithin | Lecithin |
| Ingredient | Control | 0.25% | 0.50% | 1.00% | 2.00% |
| Menhaden Fish | 0.4800 | 0.4800 | 0.4800 | 0.4800 | 0.4800 |
| Meal | | | | | |
| Gelatin | 0.1000 | 0.1000 | 0.1000 | 0.1000 | 0.1000 |
| Dextrin | 0.0300 | 0.0300 | 0.0300 | 0.0300 | 0.0300 |
| Menhaden Fish | 0.2335 | 0.2310 | 0.2285 | 0.2235 | 0.2135 |
| Oil | | | | | |
| Vitamin Premix¹ | 0.0100 | 0.0100 | 0.0100 | 0.0100 | 0.0100 |
| Mineral Premix² | 0.0400 | 0.0400 | 0.0400 | 0.0400 | 0.0400 |
| Lecithin | 0 | 0.0025 | 0.0050 | 0.0100 | 0.0200 |
| Ascorbic Acid | 0.0050 | 0.0050 | 0.0050 | 0.0050 | 0.0050 |
| Carboxy-methyl- | 0.0200 | 0.0200 | 0.0200 | 0.0200 | 0.0200 |
| cellulose | | | | | |
| Paprika | 0.0200 | 0.0200 | 0.0200 | 0.0200 | 0.0200 |
| Cellulose | 0.0570 | 0.0570 | 0.0570 | 0.0570 | 0.0570 |

¹See Appendix Table 1.
²See Appendix Table 2.

APPENDIX TABLE 1
Vitamin premix used in spotted bass
dietary formulations.

| Ingredient | g/100 g |
|---|---|
| Vitamin A Acetate | 0.154 |
| Vitamin D₃ | 0.080 |
| Vitamin E | 1.500 |
| Vitamin K | 0.220 |
| Thiamine HCl | 0.400 |
| Riboflavin | 0.300 |
| d-Calcium Pantothenate | 1.500 |
| Niacin | 3.000 |
| Pyridoxine HCl | 0.200 |
| Folic Acid | 0.150 |
| Vitamin B₁₂ | 0.300 |
| Inositol | 5.000 |
| Biotin | 0.010 |
| Dextrose | 87.186 |

APPENDIX 2
Mineral premix used in spotted bass dietary
formulations.

| Ingredient | g/100 g |
|---|---|
| Aluminum Potassium Sulfate•12H₂O | 0.2461 |
| Calcium Carbonate | 15.1338 |
| Copper Sulfate•5H₂O | 0.0629 |
| Cobalt Chloride•6H₂O | 0.0969 |
| Ferric Citrate•5H₂O | 1.2478 |
| Magnesium Sulfate | 4.1697 |
| Manganese Sulfate•H₂O | 0.0615 |
| Potassium Chloride | 25.2068 |
| Potassium Iodide | 0.0105 |
| Zinc Carbonate | 0.1534 |
| Sodium Phosphate Dibasic | 11.9262 |
| Sodium Selenite | 0.0044 |
| Solka Floc | 6.9870 |
| Calcium Phosphate Dibasic | 34.6930 |

1. A fish food composition comprising an organic fish-food meal and an agent that prevents the stratification of the food components of the fish-food meal in the gut of a fish.

2. The fish food composition of claim 1, wherein said agent that prevents the stratification of the food components of the fish-food meal is an emulsifier.

3. The fish food composition of claim 2 wherein said agent that prevents the stratification of the food components of the fish-food meal is present in an amount comprising from about 0.25% to about 6.00% of the fish-food composition by weight.

4. The fish food composition of claim 1, wherein the agent that prevents stratification of the food components is selected from the group consisting of lecithin (phosphatidyl choline), choline chloride, phosphatidylethanolamine, phosphatidic acid, Polysorbate 60, Polysorbate 65, Polysorbate 80, lysoprin, lysoforte, fatty acid esters of glycerol, sorbitan fatty acid esters, calcium stearate, cholic acid, glycerol monostearate, lactoalbumin, albumin, monoglycerides, diglycerides, sorbitan monostearate, stearyl lactate, hydroxypropyl cellulose, hydroxypropyl methylcellulose, methyl ethyl cellulose, methyl cellulose, polydimethylsiloxane ,dimethylpolysiloxane, Polyethylene 40 stearate, polyglycerol esters of interesterified ricinoleic acid, Polyoxyethylene (20) sorbitan monostearate Polyoxyethylene (20) sorbitan tristearate Polyoxyethylene (20) sorbitan monooleate, propylene glycol alginate, propylene glycol mono- and di-esters, propylene glycol esters of fatty acids, sodium lactylate, sodium oleyl lactylate, sodium stearoyl lactylate, sodium phosphates sorbitan monostearate, sorbitan tristearate, sorbitol or sorbitol syrup, sucrose acetate isobutyrate, sucrose esters of fatty acids tannins and tannic acid.

5. The fish food composition of claim 4 wherein said emulsifier is lecithin.

6. The fish food composition of claim 2, wherein said fish-food composition is coated with said emulsifier.

7. A method of producing a fish food composition, comprising spraying an emulsifier an organic meal to produce the fish food composition of claim 1.

8. A method of producing a fish food composition, comprising blending an emulsifier with an organic meal to produce the fish food composition of claim 1.

9. A method of reducing residuum stratification in the stomach of a fish, comprising providing the fish a diet comprising the fish food composition of claim 2, wherein the presence of said emulsifier decreases the stratification of the residuum in the stomach of a fish as compared to a fish food bolus that does not comprise said emulsifier.

10. A method of increasing nutrient absorption of a fish, comprising providing the fish a diet comprising the fish food composition of claim 2, wherein the presence of said emulsifier allows the food components of said fish-food to remain more unstratified in the stomach as compared to a fish food bolus that does not comprise said emulsifier wherein the greater unstratification of the food comprising said bolus increases nutrient absorption from said fish food by said fish.

11. A method of decreasing nutrient levels in fecal matter in fish, comprising providing the fish a diet comprising the fish food composition of claim 1.

12. The method of claim 9, wherein the emulsifier in the fish food composition of claim 2 comprises as least 0.25% of the fish's daily diet.

13. A method of improving feed conversion of fish, comprising providing the fish a diet comprising the fish food composition of claim 1.

14. The method of claim 9 wherein said fish is a hybrid striped bass, channel catfish or a teleost fish.

15. A method of preventing the breakdown of a bolus of formulated fish food in the gut of a comprising coating said formulated fish food in a coating of an emulsifier wherein the presence of said emulsifier reduces the breakdown of the formulated fish food into constituent foodstuff parts of the fish food.

16. The method of claim 15, wherein the presence of said emulsifier increases the gastric digestion of said fish food as compared to a similar fish food pellet that does not comprise said emulsifier.

17. A formulated fish food composition that comprises at least 0.25% lecithin.

18. The formulated fish food composition of claim 17, wherein said composition comprises at least 1% lecithin.

19. A formulated fish food composition that comprises at least 0.25% Tween 80.

20. The formulated fish food composition of claim 17, wherein said composition comprises at least 1% Tween 80.
